(19) United States
(12) Patent Application Publication
(10) Pub. No.: US 2015/0227937 A1
(43) Pub. Date: Aug. 13, 2015

(54) RANDOM BIOMETRIC AUTHENTICATION METHOD AND APPARATUS

(71) Applicant: MASTERCARD INTERNATIONAL INCORPORATED, Purchase, NY (US)

(72) Inventor: William GILES, Toronto (CA)

(73) Assignee: MASTERCARD INTERNATIONAL INCORPORATED, Purchase, NY (US)

(21) Appl. No.: 14/176,867

(22) Filed: Feb. 10, 2014

(51) Int. Cl. G06Q 20/40

(52) U.S. Cl. CPC G06Q 20/40145

(57) ABSTRACT

A system, apparatus, and computer-readable storage medium configured to authenticate users using biometric data from randomly selected digits.

### BACKGROUND

1. Field of the Disclosure

Aspects of the disclosure relate in general to financial services. Aspects include an apparatus, system, method and computer-readable storage medium to authenticate users using biometric data from randomly selected digits.

2. Description of the Related Art

Traditional forms of access control required token-based identification systems, such as a driver's license or passport, and knowledge-based identification systems, such as a password or personal identification number.

Biometrics or biometric authentication refers to the identification of humans by their characteristics or traits. Biometrics is used in computer science as a form of identification and access control.

Biometric identifiers are the distinctive, measurable characteristics used to label and describe individuals. Biometric identifiers are often categorized as physiological versus behavioral characteristics. Physiological characteristics are related to the shape of the body. Examples of such physiological characteristics are fingerprints, face recognition, DNA, palm print, hand geometry, iris recognition, retina identification and odor/scent. Behavioral characteristics are related to the pattern of behavior of a person such as typing rhythm, gait, and voice print. Some researchers have coined the term behaviormetrics to describe the latter class of biometrics.

Since biometric identifiers are unique to individuals, they can be more reliable in verifying identity than token and knowledge-based methods.

### SUMMARY

Embodiments include a system, device, method and computer-readable medium configured to authenticate users using biometric data from randomly selected digits.

A payment network comprises a network interface and a microprocessor. The network interface is configured to receive from a device a financial transaction request. The financial transaction request includes a customer Primary Account Number and a transaction amount. The processor categorizes a security level based at least in part on the transaction amount, and generates a requested sequence based on the security level. The requested sequence represents a sequence of biometric information requested from a customer. The network interface electronically transmits the requested sequence to the device, and receives a received biometric template sequence from the device. The received biometric template is captured biometric information from the customer. The customer is authenticated when the received biometric template sequence matches the requested sequence.

### BRIEF DESCRIPTION OF THE DRAWINGS

FIG. 1 illustrates an embodiment of a system configured to authenticate users using biometric data from randomly selected digits.

FIG. 2 depicts a mobile device embodiment configured to authenticate users using biometric data from randomly selected digits.

FIG. 3 is a block diagram of a payment network embodiment configured to authenticate users using biometric data from randomly selected digits.

FIG. 4 is a block diagram of an automated teller machine (ATM) embodiment configured to authenticate users using biometric data from randomly selected digits.

FIG. 5 illustrates a flowchart of a method embodiment to enroll users using biometric data.

FIG. 6 flowcharts a payment network method embodiment to authenticate users using biometric data from randomly selected digits.

FIG. 7 illustrates two hands, with each finger numbered from one to ten.

### DETAILED DESCRIPTION

One aspect of the disclosure includes the realization that the use of biometric identification can be made more secure by the inclusion of a random element that can be only addressed easily by the user wishing to be identified.

Another aspect of the disclosure includes the understanding that asking a user to present a random sequence of fingers would provide a secure, yet simple way to verify that a user wishes to authorize a financial transaction.

A further aspect of the disclosure is the realization that random biometric identification for financial transactions can be implemented in mobile devices, computers, automated teller machines, and payment networks.

Embodiments of the present disclosure include a system, method, and computer-readable storage medium configured to authenticate users using biometric data from randomly selected digits.

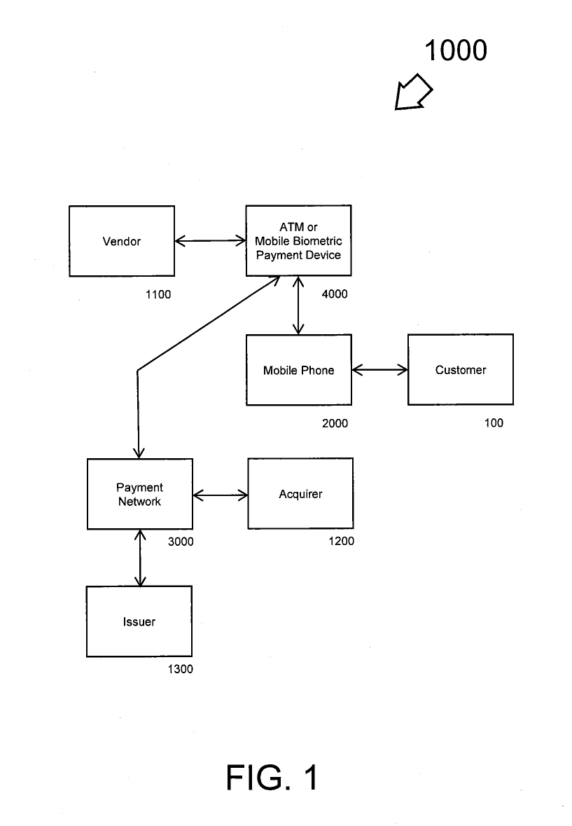

FIG. 1 illustrates an embodiment of a system 1000 configured to authenticate customers 100 using biometric data from randomly selected digits, constructed and operative in accordance with an embodiment of the present disclosure.

In system 1000, a customer 100 engages in a financial transaction with a vendor 1100 using a payment card, mobile phone 2000, automated teller machine or mobile biometric payment device 4000 in conjunction with payment network 3000. During one example transaction, payment network 3000 determines a security level of the financial transaction, and generates a random set of biometric digit sequences to the customer 100. The customer 100 authorizes the transaction by presenting the correct biometric digit sequence.

Vendor 1100 may be any provider of goods or services. The vendor 1100A may be a brick and mortar location, an optimized mobile World-Wide-Web (WWW or “web”) site, an electronic commerce site, or any combination thereof. In various embodiments, vendor 1100 offers products or services that may be paid with a payment card.

A payment card may be any credit, debit, automated teller-machine, charge, stored-value card, or the like that can be used by a cardholder and accepted by a merchant/vendor 1100 to make a payment for a purchase or in payment of some other obligation. More significantly, for purposes of this disclosure, payment cards also include any electronic payment device, including but not limited to: key-fobs, mobile phones, electronic wallets, cloud-based payment device, or other payment device known in the art. Often, payment cards are branded by a payment network, such as MasterCard™, a trademark of MasterCard International Incorporated of Purchase, N.Y.

Payment network 3000 is a payment network capable of processing payments electronically. An example payment network 3000 includes MasterCard International Incorporated. The payment network 3000 includes the set of API functions, processes, and data that allow a customer 100 to pay a vendor 1100, to ensure the proper payment format is produced and the payment is sent to the correct financial entity. Payment network 3000 produces a format to ensure payment information is processed according to the Payment Card Industry Data Security Standard (PCI DSS) and financial industry standards. The Payment Card Industry Data Security Standard (PCI DSS) is a set of requirements designed to ensure that companies that process, store or transmit credit card information maintain a secure environment.

Mobile device 2000 enables customers to authenticate and authorize a financial transaction through electronic communications with vendor 1100, and payment network 3000. In some embodiments, mobile device 2000 is a mobile phone, tablet computer, ultra-book, or other mobile device as described further herein.

An acquirer financial institution or acquirer 1200 is configured to process data from the vendor 1100 and prepares the authorization formatted data for the payment network 3000, usually sent directly to an issuer 1300.

An issuer 1300 is the financial institution that provides the credit for the payment transaction. Issuer bank 1300 processes data (authorization requests) from the acquirer 1200 and prepares the authorization-formatted response (approvals/declines).

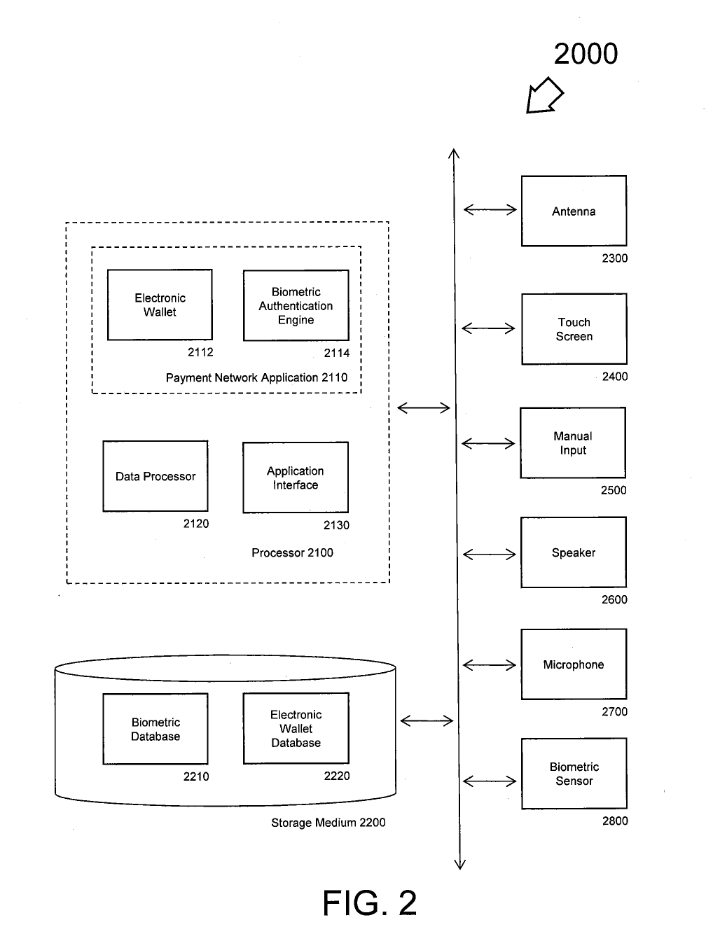

Embodiments will now be disclosed with reference to a block diagram of a mobile device 2000 of FIG. 2, constructed and operative in accordance with an embodiment of the present disclosure. Mobile device 2000 is configured to authenticate customers 100 using biometric data from randomly selected digits, constructed and operative in accordance with an embodiment of the present disclosure. When used in conjunction with a payment network server, mobile device 3000 may be used to authenticate a customer in a financial transaction.

Mobile device 2000 may run a real-time multi-tasking operating system (OS) and include at least one processor or central processing unit (CPU) 2100, a non-transitory computer-readable storage medium 2200, and an antenna 2300. An example operating system may include the Apple iOS, Google Android Operating System, Blackberry OS, FireFox mobile operating system, Microsoft Windows 8, and the like. Mobile device 2000 may further include a screen or display device 2400, manual input 2500, speaker 2600, microphone 2700, and/or biometric sensor 2800.

Processor 2100 may be any central processing unit, microprocessor, micro-controller, computational device or circuit known in the art. It is understood that processor 2100 may temporarily store instructions and data in Random Access Memory (not shown).

As shown in FIG. 2, processor 2100 is functionally comprised of a payment network application 2110, a data processor 2120, and application interface 2130.

Payment network application 2100 enables the functionality for the consumer to authorize a financial transaction using biometric authentication. Payment network application 2100 may further comprise: electronic wallet 2112, and biometric authentication engine 2114.

An electronic wallet 2112 is a program or service where users can store and control their electronic shopping information, like logins, passwords, billing address, shipping address, payment card details, contactless payment information, Primary Account Numbers, in one central place. An electronic wallet 2112 is a structure that enables electronic forms of payment, such as a contactless or near-field communication (NFC) payment, and may be associated with any electronic form of payment known in the art, such as credit cards, debit cards, pre-paid cards, charge cards, electronic checks, electronic funds transfers, or any other form of electronic payment known in the art. The information related to the electronic wallet 2112 may be stored in an electronic wallet database 2220 on a computer-readable storage media 2200.

Biometric authentication engine 2114 enables authentication of cardholders participating in a financial transaction. Further details and uses of biometric authentication engine 2114 are described further herein.

Data processor 2120 enables processor 2100 to interface with storage media 2200, antenna 2300, touch screen 2400, manual input 2500, speaker 2600, microphone 2700, biometric sensor 2800, computer memory or any other component not on the processor 2100. The data processor 2120 enables processor 2100 to locate data on, read data from, and write data to these components.

Application interface 2130 may be any graphical user interface known in the art to facilitate communication with the user of the mobile device 2000; as such, application interface 2130 may communicate with the user via touch screen 2400, manual input 2500, speaker 2600, microphone 2700, or biometric sensor 2800.

These structures may be implemented as hardware, firmware, or software encoded on a computer readable medium, such as storage media 2200. Further details of these components are described with their relation to method embodiments below.

Antenna 2300 may be any data port as is known in the art for interfacing, communicating or transferring data across a telecommunications network, computer network, near-field communications, contactless point-of-sale network, and the like. Examples of such a network include a digital cellular telephony network. Antenna 2300 allows mobile device 2000 to communicate via the digital cellular telephony network to vendor 1100, payment network 3000, or other entities. Near field communication is a set of standards for smart phones and similar devices to establish radio communication with each other by touching them together or bringing them into close proximity.

Screen 2400 may be any liquid crystal display (LCD) display, light emitting diode (LED) screen, touch-sensitive screen, or other monitor known in the art for visually displaying images and text to a user.

Manual input 2500 may be buttons, a conventional keyboard, keypad, track pad, trackball, or other input device as is known in the art for the manual input of data. In some embodiments, manual input 2500 may be integrated into a touch-sensitive screen 2400. In other embodiments, manual input 2500 may be a virtual keyboard.

In addition, a speaker 2600 may be attached for reproducing audio signals from processor 2100. Microphone 2700 may be any suitable microphone as is known in the art for providing audio signals to processor 2100.

Biometric sensor 2800 may be a digital or analog sensor to capture biometric information such as fingerprints, face recognition, DNA, palm print, hand geometry, iris recognition, retina identification and odor/scent. For illustrative purposes only, this disclosure will assume biometric sensor 2800 is a fingerprint sensor. A fingerprint sensor 2800 is an electronic device used to capture a digital image of the fingerprint pattern, and may be an optical, ultrasonic, or capacitance sensor. In some embodiments, biometric sensor 2800 may be integrated into screen 2400.

It is understood that microphone 2700, speaker 2600, and biometric sensor 2800 may include appropriate digital-to-analog and analog-to-digital conversion circuitry as appropriate.

Storage medium 2200 may be a conventional read/write memory such as a flash memory, memory stick, transistor-based memory, or other computer-readable memory device as is known in the art for storing and retrieving data.

In addition, as shown in FIG. 2, storage medium 2200 may also contain a biometric database 2210, and/or an electronic wallet database 2220. When present, biometric database 2210 is configured to store cardholder biometric information. In some embodiments, the biometric database 2210 is located at another entity such as payment network 3000. Electronic wallet database 2220 is configured to store information to support electronic wallet 2112.

It is understood by those familiar with the art that one or more of these databases 2210-2220 may be combined in a myriad of combinations.

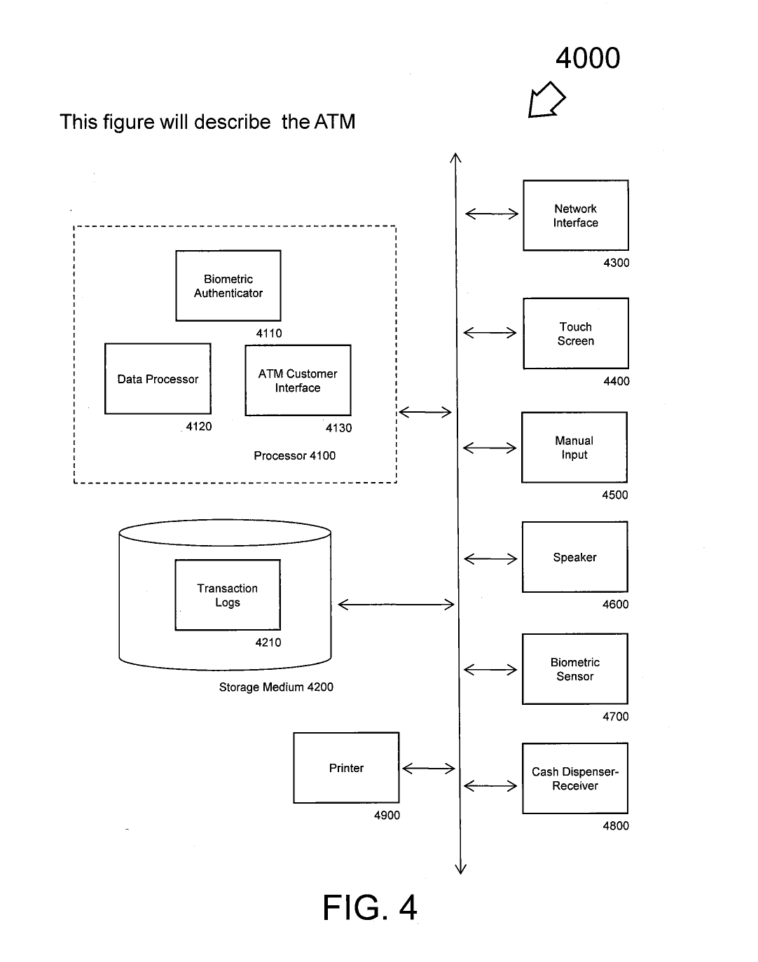

Embodiments will now be disclosed with reference to a block diagram of a point of sale/automated teller machine device 4000 of FIG. 4, constructed and operative in accordance with an embodiment of the present disclosure. Point of sale device 4000 is configured to authenticate customers 100 using biometric data from randomly selected digits, constructed and operative in accordance with an embodiment of the present disclosure. During an enrollment process, point of sale device 4000 may capture biometric information (such as finger prints) and provide the information to a payment network. During a financial transaction, the point of sale device 4000 may capture biometric information as part of a customer authentication process.

Point of sale device 4000 may run a multi-tasking operating system (OS) and include at least one processor or central processing unit (CPU) 4100, a non-transitory computer-readable storage medium 4200, a network interface 4300 and a biometric sensor 4700. An example operating system may include Advanced Interactive Executive (AIX™) operating system, UNIX operating system, or LINUX operating system, and the like. Point of sale device 4000 may further include a screen or display device 4400, manual input 4500, speaker 4600, cash dispenser-receiver 4800 and printer 4900.

Processor 4100 may be any central processing unit, microprocessor, micro-controller, computational device or circuit known in the art. It is understood that processor 4100 may temporarily store instructions and data in Random Access Memory (not shown).

As shown in FIG. 4, processor 4100 is functionally comprised of a biometric authenticator 4110, a data processor 4120, and ATM/point-of-sale user interface 4130.

Biometric authenticator 4110 is configured to take input from biometric sensor 4700. The captured image from a biometric sensor 4700 is called a “live scan.” The live scan is digitally processed by the biometric authenticator 4110 to create a biometric template (a collection of extracted features), which is stored and used for matching. During customer enrollment, the biometric template is sent to the payment network for storage and future comparison during an authentication process.

Data processor 4120 enables processor 4100 to interface with storage media 4200, network interface 4300, touch screen 4400, manual input 4500, speaker 4600, microphone 4700, biometric sensor 4700, computer memory or any other component not on the processor 4100. The data processor 4120 enables processor 4100 to locate data on, read data from, and write data to these components.

ATM user interface 4130 may be any graphical user interface known in the art to facilitate communication with the user of the point of sale device 4000; as such, ATM user interface 4130 may communicate with the user via touch screen 4400, manual input 4500, speaker 4600, or biometric sensor 4700.

These structures may be implemented as hardware, firmware, or software encoded on a computer readable medium, such as storage media 4200. Further details of these components are described with their relation to method embodiments below.

Network interface 4300 may be any data port as is known in the art for interfacing, communicating or transferring data across a telecommunications network, computer network, near-field communications, contactless point-of-sale network, and the like. Network interface 4300 allows point of sale device 4000 to communicate via a computer data network to vendor 1100, payment network 3000, or other entities. Near field communication is a set of standards for smart phones and similar devices to establish radio communication with each other by touching them together or bringing them into close proximity.

Screen 4400 may be any a liquid crystal display (LCD) display, light emitting diode (LED) screen, touch-sensitive screen, or other monitor known in the art for visually displaying images and text to a user.

Manual input 4500 may be buttons, a conventional keyboard, keypad, track pad, trackball, or other input device as is known in the art for the manual input of data. In some embodiments, manual input 4500 may be integrated into a touch-sensitive screen 4400. In other embodiments, manual input 4500 may be a virtual keyboard.

In addition, a speaker 4600 may be attached for reproducing audio signals from processor 4100.

Biometric sensor 4700 may be a digital or analog sensor to capture biometric information such as fingerprints, face recognition, DNA, palm print, hand geometry, iris recognition, retina identification and odor/scent. For illustrative purposes only, this disclosure will assume biometric sensor 4700 is a fingerprint sensor. A fingerprint sensor 4800 is an electronic device used to capture a digital image of the fingerprint pattern, and may be an optical, ultrasonic, or capacitance sensor. In some embodiments, biometric sensor 2800 may be integrated into screen 4400.

It is understood that speaker 4600, and biometric sensor 4700 may include appropriate digital-to-analog and analog-to-digital conversion circuitry as appropriate.

Storage medium 4200 may be a conventional read/write memory such as a hard drive, flash memory, memory stick, transistor-based memory, or other computer-readable memory device as is known in the art for storing and retrieving data.

In addition, as shown in FIG. 4, storage medium 4200 may also contain transaction logs 4210. Transaction logs record a listing of the financial transactions undertaken by the point of service device 4000.

Cash dispenser-receiver 4800 enables point of sale device 4000 to receive and dispense cash to customers.

Printer 4900 enables point of sale device 4000 to print transaction receipts.

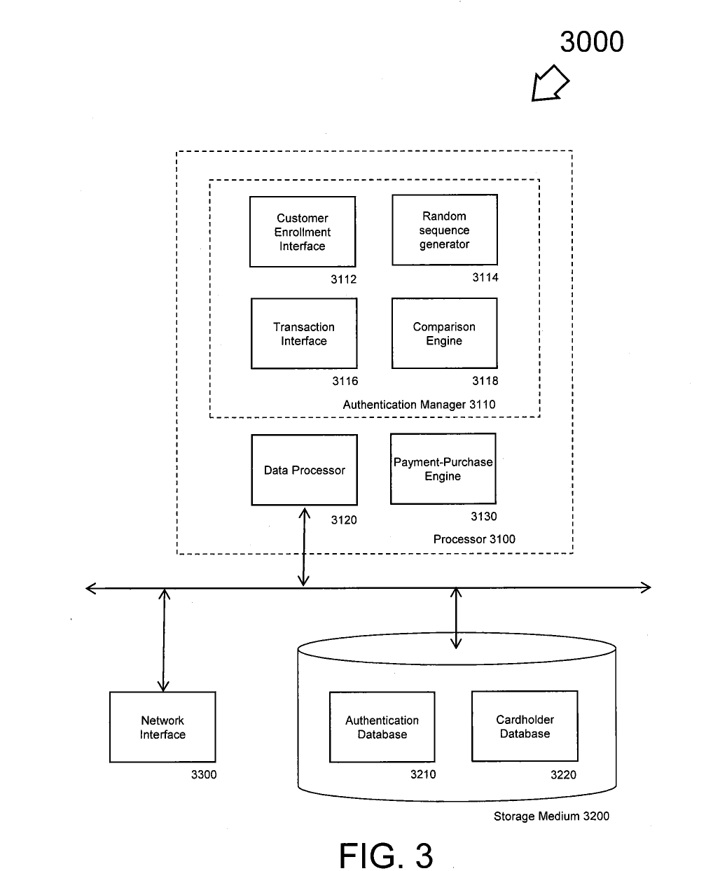

Embodiments will now be disclosed with reference to a block diagram of an exemplary payment network server 3000 of FIG. 3, constructed and operative in accordance with an embodiment of the present disclosure. In this embodiment, payment network server 3000 is configured to authenticate cardholders using random fingerprint information.

When a financial transaction takes place at a vendor, the payment network server 3000 embodiment evaluates the level of authentication for the transaction. In some instances, the level of authentication may relate to the dollar amount in the transaction, and also correspond to the number of biometric digit information requested from the customer. For example a $5 transaction might rate a low level of authentication, where biometric information from a single finger (to be specified by the payment network server) is needed to authenticate and authorize the transaction. Conversely, a very large transaction may require a specific sequence of four fingers to authenticate the customer and authorize the transaction. It is understood that any sequence of fingers may be used; however a sequence of one to five fingers may be most common. The payment network server 3000 generates a sequence of fingers to be scanned from the customer on a biometric sensor. The biometric sensor may be on a point-of-sale/ATM device 4000, or mobile device 2000, for example.

Payment network server 3000 may run a multi-tasking operating system (OS) and include at least one processor or central processing unit (CPU) 3100, a non-transitory computer-readable storage medium 3200, and a network interface 3300. An example operating system may include Advanced Interactive Executive (AIX™) operating system, UNIX operating system, or LINUX operating system, and the like.

Processor 3100 may be any central processing unit, microprocessor, micro-controller, computational device or circuit known in the art. It is understood that processor 3100 may temporarily store instructions and data in Random Access Memory (not shown).

As shown in FIG. 3, processor 3100 is functionally comprised of an authentication manager 3110, a payment-purchase engine 3130, and a data processor 3120.

Authentication manager 3110 may further comprise: user enrollment interface 3112, random sequence generator 3114, transaction interface 3116, and comparison engine 3118.

User enrollment interface 3112 is any user interface known in the art to receive and process biometric information. In some embodiments, user enrollment interface 3112 receives the biometric information as biometric templates from either a mobile device 2000, point of sale device 4000, or any other device known in the art with a biometric sensor.

Random sequence generator 3114 is the portion of the authentication manager 3110 that generates a random or pseudo-random sequence.

Transaction interface 3116 facilitates the communication between authentication manager 3110 and payment-purchase engine 3130. In some embodiments, transaction interface 3116 further facilitates the transfer of biometric identification information to the comparison engine 3118.

Comparison engine 3118 is configured to match provided candidate biometric information with previously stored templates. In this example embodiment, comparison engine 3118 is configured to compare previously stored templates of fingerprints against candidate fingerprints for authentication purposes. In some embodiments, the original image is directly compared with the candidate image. However, in other embodiments, comparison engine 3118 only compares certain features of the finger print pattern such as the arch, whorl, and loop between a previously stored template and a candidate fingerprint. In yet other embodiments, the fingerprint matching occurs at the mobile device 2000 or point of sale device 4000, and a corresponding string of data is sent to the comparison engine for verification.

Payment-purchase engine 3130 performs payment and purchase transactions, and may do so in conjunction with the authentication method described herein.

Data processor 3120 enables processor 3100 to interface with storage media 3200, network interface 3300 or any other component not on the processor 2100. The data processor 3120 enables processor 3100 to locate data on, read data from, and write data to these components.

These structures may be implemented as hardware, firmware, or software encoded on a computer readable medium, such as storage media 3200. Further details of these components are described with their relation to method embodiments below.

Network interface 3300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 3300 allows payment network server 3000 to communicate with vendors 1100, point of sale device 4000, mobile device 2000, acquirer 1400, and/or issuer 1300.

Computer-readable storage media 3200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage media 3200 may be remotely located from processor 3100, and be connected to processor 3100 via a network such as a local area network (LAN), a wide area network (WAN), or the Internet.

In addition, as shown in FIG. 3, storage media 3200 may also contain an authentication database 3210, a cardholder database 3220, and a cardholder database 3220. Authentication database 3210 is configured to store biometric identification information. In some embodiments, the biometric identification information may be stored as a hash. Cardholder database 3220 facilitates the look-up of issuers 1300 and cardholder information.

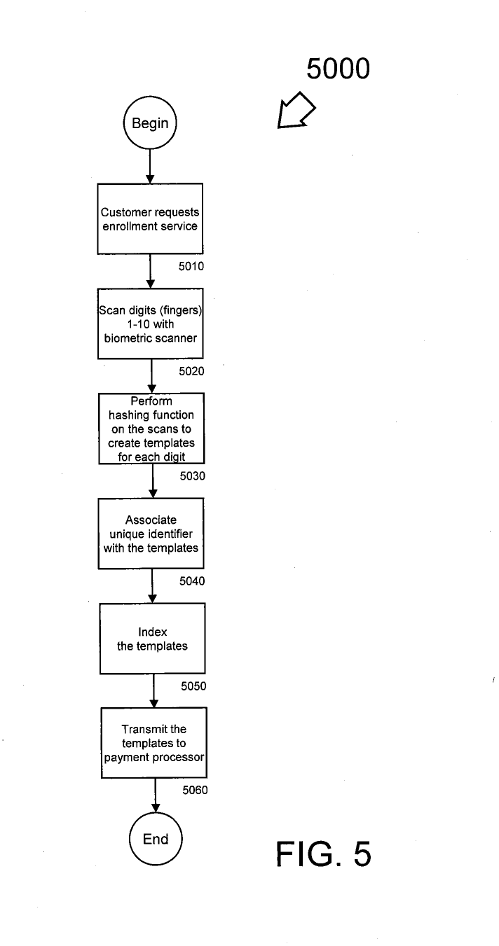

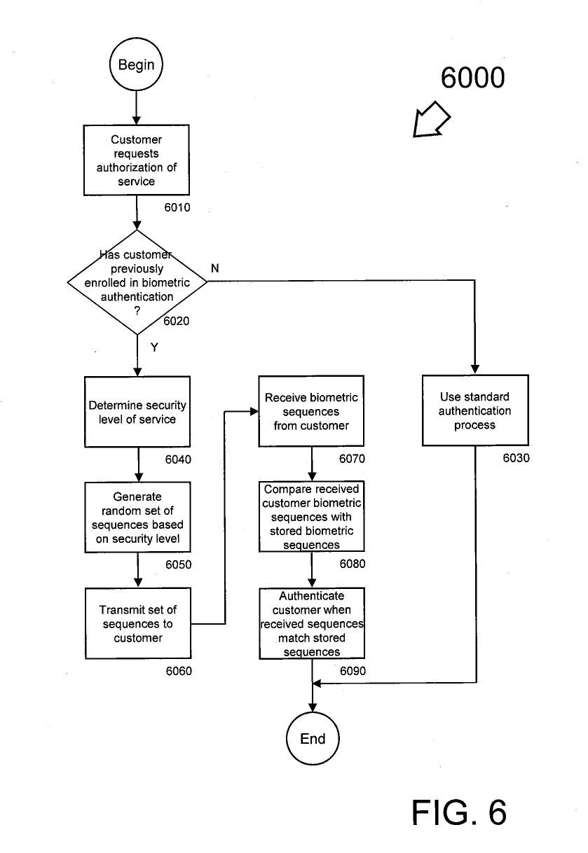

It is understood by those familiar with the art that one or more of these databases 3210-3220 may be combined in a myriad of combinations. The function of these structures may best be understood with respect to the flowcharts of FIGS. 5-6, as described below.

We now turn our attention to method or process embodiments of the present disclosure, FIGS. 5-6. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 5 illustrates a flowchart of a method embodiment 5000 to enroll users using biometric data, constructed and operative in accordance with an embodiment of the present disclosure. Enrollment may take place using a customer's mobile device 2000, an automated teller machine 4000, or any other similar device with a biometric/fingerprint sensor. In some embodiments, the mobile device 2000, automated teller machine 4000, work in conjunction with payment network 3000 to enroll the customer 100. For ease of explanation, this example embodiment describes enrollment using a mobile device 2000 running a payment network application 2110.

Initially, the customer 100 requests enrollment in the random biometric authentication process using a mobile device with a biometric/fingerprint sensor, block 5010.

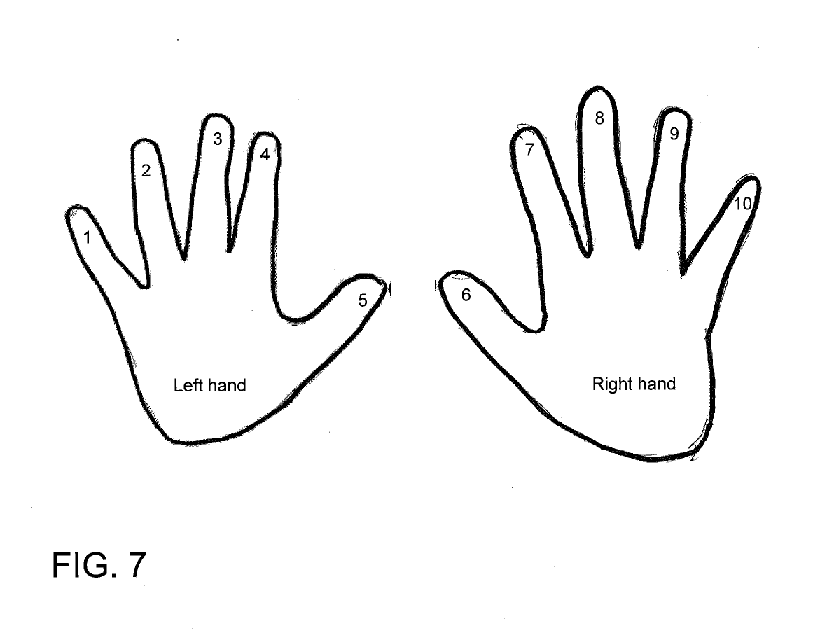

A plurality of fingers or digits is scanned with the biometric sensor, block 5020. For some customers, each of the ten fingers may be scanned. For illustrative purposes only, FIG. 7 depicts two hands with fingers numbered from one to ten. It is understood that in some cultures and implementations, fingers may be numbered differently and/or in a different order. In some embodiments, other forms of biometric information may be used, such as face recognition, DNA, palm print, hand geometry, iris recognition, and retina identification. Regardless of the form of biometric information used, a plurality of biometric information is captured by biometric authentication engine 2114.

Biometric authentication engine 2114 performs a mathematic hashing function on the scan to create a template for each digit, block 5030.

A unique identifier is associated with the template, block 5040. The unique identifier may be a payment card Primary Account Number, government identification number (i.e. Social Security number or driver's license number), or other identifier. The unique identifier is dependent on implementation, and is used to associate the biometric information with the user.

The templates are indexed using the unique identifier and identified according to the type of biometric information. For example, a first template may be identified as representing the fingerprint of a left-hand little-finger, a second template as a left-hand ring finger, a third template as a left-hand middle-finger, and so on.

At block 5060, the indexed templates may be transmitted to a user enrollment interface 3112 of a payment network 3000 for storage in an authentication database 3210. In alternate embodiments, the indexed templates may be retained on the mobile device 2000 and stored in the biometric database 2210.

FIG. 6 flowcharts a payment network method embodiment 6000 to authenticate users using biometric data from randomly selected digits, constructed and operative in accordance with an embodiment of the present disclosure. In process 6000, the payment network 3000 authenticates a customer via information transmitted to it by a customer's mobile device 2000, point-of-sale device or automated teller machine 4000.

At block 6010, payment-purchase engine 3130 receives a real-time request from a customer 100 or vendor 1100 seeking to authorize a financial payment or other financial transaction on behalf of customer 100. The payment authorization request typically contains an identifier for the vendor 1100, a financial transaction amount, and a Primary Account Number for the customer 100.

If the user has not previously enrolled in biometric authentication, as determined by transaction interface 3116 at decision block 6020, a standard authentication process by the payment-purchase engine 3130, block 6030, is used. The determination may be made by matching the Primary Account Number for the transaction with a corresponding entry in a cardholder database 3220 or authentication database 3210.

If the user has enrolled in biometric authentication, as determined at decision block 6020, process 6000 continues at the transaction interface 3116, block 6040.

At block 6040, the payment network 3000 determines the level of security required by the financial transaction. The level of security may relate to the amount of the transaction. For example, a low-dollar-amount transaction may require a lower level of security than a high-dollar-amount transaction.

Security level may also be influenced by other factors, such as a history of fraud associated with the primary account number or customer, the vendor, the location of the vendor seeking the transaction (i.e. an originating location of the financial transaction request), or customer purchase transaction history. For example, if the customer is seeking to perform a transaction in a high-risk (high-fraud) locale, the level of security may be higher.

Depending upon the security level, random sequence generator 3114 creates a random sequence of biometric identification information that the customer 100 will have to provide the biometric sensor. For example, in a low security-level transaction, the random sequence generator 3114 may prompt the customer for a random fingerprint, such as the pointer finger of the right-hand. For transactions requiring higher levels of security, the random sequence generator 3114 may prompt the customer for a random sequence of fingerprints. Suppose the security level of the transaction requires three fingerprints be provided, the random sequence generator 3114 will prompt the customer to provide three fingerprints randomly selected by the authentication manager 3110.

In some embodiments, the random sequence generator 3114 will provide a random numeric sequence, with each numeric digit corresponding to fingers 1-10 of the customer 100.

The sequence is transmitted to the device from which the customer is seeking to authenticate the transaction, block 6060. The sequence may be transmitted via any method known in the art, including via a dedicated mobile application on mobile phone 2000, via short message service (SMS), text message, electronic mail, or automated voice telephone call.

The customer presents the requested sequence of biometric information to the device, which transmits the resulting biometric template to payment network 3000 for confirmation.

When the biometric sequences are received from the customer 100, via the mobile device 2000 or ATM/point-of-sale device 4000, the comparison engine 3118 compares the received templates to templates associated with the Primary Account Number stored in the authentication database 3210, block 6080. When the received sequence templates match the randomly generated sequences requested, the customer is authenticated and the transaction is allowed to continue, assuming the customer is otherwise allowed to participate in the transaction. In other words, if the financial transaction would otherwise be rejected, the transaction would still be rejected. However, if the customer would otherwise be approved, the customer would be approved.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A payment network method comprising:
receiving at the payment network, from a device via a network interface, a financial transaction request, the financial transaction request including a customer Primary Account Number and a transaction amount;
categorizing, with a microprocessor, a security level based at least in part on the transaction amount;
generating, with the microprocessor, a requested sequence based on the security level, the requested sequence representing a sequence of biometric information requested from a customer;
electronically transmitting, via the network interface, the requested sequence to the device;
receiving, via the network interface, a received biometric template sequence from the device, the received biometric template representing a captured biometric information from the customer;
authenticating the customer when the received biometric template sequence matches the requested sequence.

2. The method of claim 1 further comprising:
approving the financial transaction request after the customer is authenticated.

3. The method of claim 1 further comprising:
declining the financial transaction request when the received biometric template sequence does not match the requested sequence.

4. The method of claim 2 wherein categorizing the security level based at least in part on the customer's transaction history.

5. The method of claim 2 wherein categorizing the security level based at least in part on an originating location of the financial transaction request.

6. The method of claim 5 wherein the sequence of biometric information requested from a customer is a sequence of fingerprints.

7. The method of claim 6 wherein the sequence of fingerprints is randomly chosen.

8. A payment network apparatus comprising:
a network interface configured to receive from a device a financial transaction request, the financial transaction request including a customer Primary Account Number and a transaction amount;
a microprocessor configured to categorize a security level based at least in part on the transaction amount, to generate a requested sequence based on the security level, the requested sequence representing a sequence of biometric information requested from a customer;
wherein the network interface is further configured to electronically transmit the requested sequence to the device, and to receive a received biometric template sequence from the device, the received biometric template representing a captured biometric information from the customer;
wherein the microprocessor is further configured to authenticate the customer when the received biometric template sequence matches the requested sequence.

9. The apparatus of claim 8 further comprising:
approving the financial transaction request after the customer is authenticated.

10. The apparatus of claim 8 further comprising:
declining the financial transaction request when the received biometric template sequence does not match the requested sequence.

11. The apparatus of claim 9 wherein categorizing the security level based at least in part on the customer's transaction history.

12. The apparatus of claim 9 wherein categorizing the security level based at least in part on an originating location of the financial transaction request.

13. The apparatus of claim 12 wherein the sequence of biometric information requested from a customer is a sequence of fingerprints.

14. The apparatus of claim 13 wherein the sequence of fingerprints is randomly chosen.

15. A non-transitory computer readable medium encoded with data and instructions, when executed by a computing device the instructions causing the computing device to:
receive at a payment network, from a device via a network interface, a financial transaction request, the financial transaction request including a customer Primary Account Number and a transaction amount;
categorize, with a microprocessor, a security level based at least in part on the transaction amount;
generate, with the microprocessor, a requested sequence based on the security level, the requested sequence representing a sequence of biometric information requested from a customer;
electronically transmit, via the network interface, the requested sequence to the device;
receive, via the network interface, a received biometric template sequence from the device, the received biometric template representing a captured biometric information from the customer;
authenticatie the customer when the received biometric template sequence matches the requested sequence.

16. The non-transitory computer readable medium of claim 15 further causing the computing device to:
approve the financial transaction request after the customer is authenticated.

17. The non-transitory computer readable medium of claim 15 further causing the computing device to:
decline the financial transaction request when the received biometric template sequence does not match the requested sequence.

18. The non-transitory computer readable medium of claim 16 wherein categorizing the security level based at least in part on the customer's transaction history.

19. The non-transitory computer readable medium of claim 16 wherein categorizing the security level based at least in part on an originating location of the financial transaction request.

20. The non-transitory computer readable medium of claim 19 wherein the sequence of biometric information requested from a customer is a sequence of fingerprints.
